(19) United States
(12) Patent Application Publication
(10) Pub. No.: US 2023/0065437 A1
(43) Pub. Date: Mar. 2, 2023

(54) ACIDIZING OF SUBTERRANEAN FORMATIONS WITH PLACEMENT OF SCALE INHIBITOR

(71) Applicant: Halliburton Energy Services, Inc., Houston, TX (US)

(72) Inventors: Enrique Antonio Reyes, Houston, TX (US); Aaron M. Beuterbaugh, Houston, TX (US); Kristina Henkel Holan, Houston, TX (US); Travis Hope Larsen, Houston, TX (US)

(21) Appl. No.: 17/404,780

(22) Filed: Aug. 17, 2021

(51) Int. Cl. C09K 8/528

(52) U.S. Cl. CPC C09K 8/528

(57) ABSTRACT

Methods for inhibiting scale formation in a subterranean formation are provided. In some embodiments the present disclosure includes providing an organophosphorous compound including a phosphonoalkyl moiety; providing an acid component; mixing at least the organophosphorous compound including a phosphonoalkyl moiety and the acid component to form a treatment fluid; introducing the treatment fluid into at least a portion of a subterranean formation; contacting at least a portion of an acid-reactive substance disposed within the subterranean formation with the treatment fluid; forming a spent treatment fluid by allowing the acid component to at least partially spend against the portion of the acid-reactive surface; and allowing the spent treatment fluid to inhibit the formation of at least an amount of scale.

### BACKGROUND

The present disclosure relates to methods, systems, and compositions for relating to acid-promoted processes during subterranean treatment operations.

Treatment fluids can be used in a variety of subterranean treatment operations. Such treatment operations can include, without limitation, drilling operations, stimulation operations, production operations, remediation operations, sand control treatments, and the like. As used herein, the terms “treat,” “treatment,” “treating,” and grammatical equivalents thereof refer to any subterranean operation that uses a fluid in conjunction with achieving a desired function and/or for a desired purpose. Use of these terms does not imply any particular action by the treatment fluid or a component thereof, unless otherwise specified herein. More specific examples of illustrative treatment operations can include, for example, drilling operations, fracturing operations, gravel packing operations, acidizing operations, scale dissolution and removal operations, sand control operations, consolidation operations, and the like.

Acidic treatment fluids are frequently used in conducting various subterranean treatment operations. Illustrative uses of acidic treatment fluids during subterranean treatment operations include, for example, matrix acidizing of siliceous and/or non-siliceous formations, scale dissolution and removal operations, gel breaking, acid fracturing, and the like. When acidizing a non-siliceous material, such as a carbonate material, mineral acids such as hydrochloric acid often may be sufficient to affect dissolution. Organic acids such as formic acid or acetic acid also may be used in a similar manner to hydrochloric acid when dissolving a non-siliceous material. Siliceous materials, in contrast, may require the use of hydrofluoric acid to readily dissolve the material, optionally in combination with other mineral acids or organic acids. Similar considerations apply when dissolving scale.

Although carbonate minerals can be readily dissolved with both mineral acids and organic acids, there are operations like acidizing treatments of subterranean formations in which the acid's reactivity with carbonate minerals may be excessive and may lead to various undesirable effects. For example, excessively rapid reaction of a carbonate mineral with an acid can lead to wellbore erosion and excessive or inefficient acid reaction (spending) in the near wellbore area or reservoir, rather than the desired wormhole formation or the creation of other conductive channels, or asperities, in the formation matrix in order to increase, or restore, its permeability, or hydraulic conductivity. As used herein, the term “wormhole” refers to a conduit or channel generated in the matrix of a subterranean formation that positively contributes to generating conductivity or increased incremental permeability. Mineral scaling may also become problematic when a carbonate mineral is reacted with an acid. The reaction of mineral and organic acids with soft and friable matrices, particularly at elevated formation temperatures, can often occur too rapidly and can lead to undesirable matrix deconsolidation or severe erosion. Finally, when using an acid to break a gel or to remove an acid-degradable filter cake within a wellbore, reactivity issues of the formation matrix may need to be taken into account in choosing an appropriate treatment protocol.

### BRIEF DESCRIPTION OF THE DRAWINGS

Some specific embodiments of the disclosure may be understood by referring, in part, to the following description and the accompanying drawings.

FIG. 1 is a diagram illustrating an example of a well bore assembly that may be used in accordance with certain embodiments of the present disclosure.

FIG. 2 is a graph illustrating testing results obtained in accordance with certain embodiments of the present disclosure.

FIG. 3 is a graph illustrating testing results obtained in accordance with certain embodiments of the present disclosure.

FIG. 4 is a graph illustrating testing results obtained in accordance with certain embodiments of the present disclosure.

While embodiments of this disclosure have been depicted and described and are defined by reference to certain embodiments of the disclosure, such references do not imply a limitation on the disclosure, and no such limitation is to be inferred. The subject matter disclosed is capable of considerable modification, alteration, and equivalents in form and function, as will occur to those skilled in the pertinent art and having the benefit of this disclosure. The depicted and described embodiments of this disclosure are examples only, and not exhaustive of the scope of the disclosure.

### DETAILED DESCRIPTION

Illustrative embodiments of the present disclosure are described in detail herein. In the interest of clarity, not all features of an actual implementation may be described in this specification. It will of course be appreciated that in the development of any such actual embodiment, numerous implementation-specific decisions may be made to achieve the specific implementation goals, which may vary from one implementation to another. Moreover, it will be appreciated that such a development effort might be complex and time-consuming but would nevertheless be a routine undertaking for those of ordinary skill in the art having the benefit of the present disclosure.

To facilitate a better understanding of the present disclosure, the following examples of certain embodiments are given. In no way should the following examples be read to limit, or define, the scope of the invention. Embodiments of the present disclosure involving wellbores may be applicable to horizontal, vertical, deviated, or otherwise nonlinear wellbores in any type of subterranean formation. Embodiments may be applicable to injection wells, monitoring wells, and production wells, including hydrocarbon or geothermal wells. Furthermore, storage wells where the permanent or temporary entrapment of industrial emissions containing gases such as carbon dioxide (CO₂) primarily, but also others such as nitrogen oxides (NOₓ) or sulfur oxides (SOₓ); or halogenated gases such as fluorocarbons, oxygenenated fluorocarbons, or chlorocarbons or other organo-halogenated small molecules (C1 to C5), may also be applicable.

The present disclosure relates to methods, systems, and compositions for acid-promoted processes, and, more specifically, to methods for inhibiting scale formation in a subterranean formation. In some embodiments, the treatment fluids and methods described herein include providing or forming a treatment fluid that includes an organophosphorous compound comprising a phosphonoalkyl moiety that is at least partially solubilized in an acid component (an acid, acid-generating compound, or both); placing the treatment fluid into at least a portion of a subterranean formation, wherein the subterranean formation includes one or more acid-reactive surfaces; forming a spent treatment fluid by allowing the acid component to spend against the acid-reactive surface; and allowing the spent treatment fluid to inhibit the formation of scale within the subterranean formation. Some embodiments may involve introducing a treatment fluid described herein (e.g., a treatment fluid that includes an acid component and an organophosphorous compound comprising a phosphonoalkyl moiety) into a wellbore penetrating a subterranean formation that comprises a carbonate mineral; reacting the acid component with the carbonate mineral in the presence of the organophosphorous compound comprising a phosphonoalkyl moiety, such that the acid at least partially spends as the pH of the treatment fluid rises; and allowing the organophosphorous compound comprising a phosphonoalkyl moiety to at least partially inhibit the formation of scale within the subterranean formation.

In some embodiments, the treatment fluids and methods described herein can be used in fracture acidizing operations of subterranean formations comprising a carbonate mineral. That is, in some embodiments, the treatment fluids described herein can be introduced to a subterranean formation at or above a fracture gradient pressure of the subterranean formation.

In some embodiments, the treatment fluids and methods described herein can be used in matrix acidizing operations of subterranean formations comprising a carbonate mineral. That is, in some embodiments, the treatment fluids described herein can be introduced to a subterranean formation below a fracture gradient pressure of the subterranean formation.

Without intending to be limited to any particular theory or mechanism, it is believed that the organophosphorous compounds comprising a phosphonoalkyl moiety of the present disclosure may inhibit the formation of scale within a subterranean formation. For example, in some embodiments, the organophosphorous compounds comprising a phosphonoalkyl moiety may inhibit formation of scale on a portion of a surface of the subterranean formation. In other embodiments, the organophosphorous compounds comprising a phosphonoalkyl moiety may inhibit formation of scale on a surface of a piece of down-hole equipment. In other embodiments, the organophosphorous compounds comprising a phosphonoalkyl moiety may inhibit formation of scale on a surface of a pipe. In still other embodiments, in some embodiments, the organophosphorous compounds comprising a phosphonoalkyl moiety may inhibit formation of scale on a combination of one or more surfaces. Suitable organophosphorous compounds comprising a phosphonoalkyl moiety may include, but are not limited to, N-(phosphonoalkyl)iminodiacetic acids; N-(carboxymethyl)-N-(phosphonomethyl)¬¬glycine; glycine, N,N′-1,2-ethanediylbis(N-(phosphonomethyl); glyphosine; N-(2-hydroxyethyl)imino-bis(methylphosphonic acid); and phosphonic acids including, but not limited to, aminotrimethylene phosphonic acid; sodium aminotris(methylenephosphonate); phosphonic acid, P,P′-((2-propen-1-ylimino)bis(methylene))bis-; phosphonic acid, P,P′,P″-(nitrilotris(methylene))tris-; (nitrilotris(methylene))trisphosphonic acid; ((methylimino)dimethylene)bisphosphonic acid; phosphonic acid, P,P′,P″,P′″-(oxybis(2,1-ethane-diylnitrilobis(methylene))tetrakis-; ((propylimino)bis(methylene))diphosphonic acid; phosphonic acid; P,P′,P″-(nitrilotris(methylene))tris-; (ethylenedinitrilo)-tetramethylenephosphonic acid; ethylenebis(nitrilodimethylene)tetraphosphonic acid; (ethylenebis(nitrilobis¬(methylene)))-tetrakisphosphonic acid; tetrasodium tetrahydrogen (ethane-1,2-diylbis(nitrilobis¬(methylene)))-tetrakisphosphonate; 6-(bis(phosphonomethyl)amino)hexanoic acid; (phenyl¬methyl)imino)-bis(methylene)bisphosphonic acid; a sodium, potassium, ammonium, or alkylammonium salt or salts of any group member herein, and any mixtures thereof.

Subterranean formations including a wide variety of acid-reactive surfaces or substances may be treated using the organophosphorous compound comprising a phosphonoalkyl moiety of the present disclosure. In certain embodiments, the acid-reactive surface may comprise a metal, a metal salt, a mineral (particularly a carbonate mineral), a metal carbonate, an acid-degradable polymer, or the like. In some embodiments, the acid-reactive surface may be present in a wellbore penetrating a portion of a subterranean formation during a subterranean treatment operation, such as, for example, an acidizing operation. In some embodiments, the acid-reactive surface may be present when degrading a gel or a filter cake with acid following a drilling operation. In other embodiments, the acid-reactive surface may be natively present or naturally occurring in the wellbore. In still other embodiments, the acid-reactive surface may have been placed in the wellbore during a prior or concurrent subterranean treatment operation, such as during placement of a fluid loss additive. In certain embodiments, the acid-reactive surface may comprise, for example, a matrix comprising the subterranean formation, at least a portion of a particulate pack (e.g., a proppant pack or a gravel pack), or at least a portion of a metal tool that is present in the wellbore.

In certain embodiments, the organophosphorous compound comprising a phosphonoalkyl moiety may be or function as an acid-compatible chelating agent. In some embodiments, the organophosphorous compound comprising a phosphonoalkyl moiety may inhibit scale formation in a subterranean formation after completion of the acidizing treatment. As used herein, “scale” refers to a mineral or solid salt deposit that forms when the saturation of formation or treatment water (containing acid reaction products) to one or more minerals is affected by changing physical conditions (such as temperature, pressure, or composition), thus causing minerals and salts previously in solution to precipitate into solids. Chelating agents (also known as ligands or chelants) are materials that may be employed to control undesirable reactions of dissolved metal ions. In oilfield chemical treatments, chelating agents are frequently added to matrix stimulations to prevent precipitation of total dissolved solids. In addition, chelating agents may be used as components in many scale removal/prevention formulations. Chelating agents form complexes with metal ions by forming coordinate bonds with the metal ion. Chelating agents sequester and inactivate the metal ion so it does not easily react with other elements or ions to produce precipitates or scale. Chelating agents can also dissolve the mineral without the use of a primary acid fluid comprised of a mineral or an organic acid, and can also dissolve scales (e.g., calcium carbonate, magnesium carbonate, dolomite, and iron carbonate).

In some embodiments, the methods described herein may further comprise adsorbing a portion of the organophosphorous compound comprising a phosphonoalkyl moiety to a surface in the wellbore and/or subterranean formation, thereby inhibiting scale formation thereon. Without intending to be limited to any particular theory or mechanism, it is believed that the phosphonate group of the organophosphorous compound comprising a phosphonoalkyl moiety may adsorb to surfaces and inhibit scale formation. Scale deposits can form on any surface in a downhole operation (e.g., a formation face, a wellbore tool in the wellbore, equipment at the surface, and the like, and combinations thereof), including subterranean formations, production tubing, gravel packing screens, and other well bore equipment. Scale can develop almost immediately or build up over time before becoming problematic. The effect scale has on productivity depends on the type, location, and the mass deposited. Scale formation can become so severe as to restrict or even completely choke production. The formation of scale can decrease permeability of the subterranean formation, reduce well productivity and shorten the lifetime of production equipment. To clean scale from wells and equipment, it is generally necessary to stop production, which is both time-consuming and costly.

In some embodiments, the ability of the organophosphorous compound comprising a phosphonoalkyl moiety to inhibit the formation of scale may be dependent on pH. For example, when the organophosphorous compound comprising a phosphonoalkyl moiety is in a treatment fluid having a pH of 1, it may not be able to provide any scale inhibition. However, as the pH of the treatment fluid rises, the organophosphorous compound comprising a phosphonoalkyl moiety may begin to provide scale inhibition. In some embodiments, the organophosphorous compound comprising a phosphonoalkyl moiety may inhibit scale formation at a pH greater than 1. In some embodiments, the organophosphorous compound comprising a phosphonoalkyl moiety may inhibit scale formation at a pH greater than 2. In some embodiments, the organophosphorous compound comprising a phosphonoalkyl moiety may inhibit scale formation at a pH in the range of from about 2 to about 9. In some embodiments, the organophosphorous compound comprising a phosphonoalkyl moiety may inhibit scale formation at a pH in the range of from about 2 to about 7. In other embodiments, the organophosphorous compound comprising a phosphonoalkyl moiety the organophosphorous compound comprising a phosphonoalkyl moiety may inhibit scale formation at a pH in the range of from about 2.5 to about 5. In still other embodiments, the organophosphorous compound comprising a phosphonoalkyl moiety may inhibit scale formation at a pH in the range of from about 3 to about 4.

In certain embodiments, the treatment fluids including an organophosphorous compound comprising a phosphonoalkyl moiety and an acid component of the methods and systems of the present disclosure may be used to form a spent treatment fluid. As used herein, the term “spent treatment fluid” refers to a treatment fluid containing an acid that has contacted an acid-reactive surface, thereby allowing at least a portion of the acid to react with the acid-reactive surface. In some embodiments, the treatment fluid may contact an acid-reactive surface within the subterranean formation and the acid may begin to spend against the acid-reactive surface, thereby raising the pH. In certain embodiments, the acid spends against the acid-reactive surface in an amount sufficient to raise the pH to a level suitable to allow the organophosphorous compound comprising a phosphonoalkyl moiety to inhibit scale formation.

In some embodiments, the acid-reactive surface may be a carbonate material. Illustrative carbonate minerals that may be protected from an organic acid or a mineral acid in various embodiments of the present disclosure may include, for example, calcite (calcium carbonate), dolomite (calcium magnesium carbonate), siderite (iron carbonate), aragonite, vaterite, and any combination thereof. Calcite and dolomite may be particularly prevalent in carbonate formations. Optionally, other minerals may be admixed with calcite and/or dolomite in any combination. Other minerals that may be present in a calcite or dolomite surface being protected by the embodiments of the present disclosure include, for example, iron sulfide, iron carbonate, silicates and aluminosilicates including clays.

In some instances, the carbonate minerals may react with the acid (or acid generated by the acid-generating compound) resulting in the bulk erosion of the carbonate mineral, in the formation of wormholes in the carbonate mineral, or in a combination thereof. For example, in some instances, the subterranean formation may comprise calcium carbonate at a sufficient concentration (e.g., about 60% or greater) such that reacting the acid with the carbonate mineral forms predominantly wormholes.

As discussed above, the organophosphorous compound comprising a phosphonoalkyl moiety, when deprotonized (ionized), may complex metal ions. Illustrative sources of the metal ion may include, for example, treatment fluids (e.g., acidizing fluids), leak-off additives, a native carbonate mineral present in the subterranean formation, a non-native carbonate material that was previously introduced to the subterranean formation (e.g., calcium carbonate particles), metal ions being leached into the subterranean formation through corrosion of a drilling tool or wellbore pipe, for example, or a combination thereof. Illustrative sources of the metal ion may include, for example, a native carbonate mineral present in the subterranean formation, a non-native carbonate material that was previously introduced to the subterranean formation (e.g., calcium carbonate particles), metal ions being leeched into the subterranean formation through corrosion of a drilling tool or wellbore pipe, for example, or a combination thereof. Illustrative metal ions that may be present in a subterranean formation due to dissolution of a carbonate mineral may include, but are not limited to, calcium ions, magnesium ions, iron ions, primarily and in certain circumstances aluminum, sodium, potassium, ions, and any combination thereof. Illustrative metal ions that may be present in a subterranean formation due to corrosion mineral may include, but are not limited to, iron ions, or any other metal ion resulting from the dissolution of iron alloys by an acid. In some embodiments, the metal ion being complexed by the phosphonoalkyl agent may include, for example, a calcium ion, a magnesium ion, an iron ion, and any combination thereof. The metal ion may be complexed with the organophosphorous compound comprising a phosphonoalkyl moiety through a direct interaction of the organophosphorous compound comprising a phosphonoalkyl moiety with a surface in the subterranean formation (i.e., a carbonate mineral surface), or the metal ion may be complexed by the organophosphorous compound comprising a phosphonoalkyl moiety after the metal ion has undergone an initial dissolution by the acid.

According to several exemplary embodiments, the organophosphorous compound comprising a phosphonoalkyl moiety binds to metal cations (e.g., alkaline earth metals) commonly associated with acidizing-matrix stimulation such as magnesium (Mg²⁺), calcium (Ca²⁺), strontium (Sr²⁺), barium (Ba²⁺), and multivalent ions such as iron (Fe²⁺ and Fe³⁺), and chromium (Cr²⁺, Cr³⁺ and titanium (Ti³⁺ or Ti⁴⁺), zirconium (Zr⁴⁺ or Zr⁶⁺), vanadium (V⁴⁺), copper (Cu²⁺), nickel (Ni²⁺) to form stable water-soluble complexes. Binding the metal cations results in reduction, minimization, or elimination of insoluble products that may lead to precipitation and formation damage.

According to several exemplary embodiments, the organophosphorous compound comprising a phosphonoalkyl moiety advantageously has very acidic protons. The pKa values for N-phosphonomethyl iminodiacetic acid (PMIDA), for example, are about 2.0, 2.3, 5.6, and 10.8. The protons are not tightly held by the organophosphorous compound comprising a phosphonoalkyl moiety and are more easily released in solution, even at low pH. The first two pKa values of PMIDA are substantially lower than known chelating agents, such as glutamic acid diacetic acid (GLDA) (pKa values of about 2.6 and about 3.5), ethylenediaminetetraacetic acid (EDTA) (pKa values of about 2.0, 2.7, and 6.2), tetrasodium 3-hydroxy-2,2′-iminodisuccinate (HIDS) (pKa values of about 2.83), N-(2-hydroxyethyl)ethylenediaminetriacetic acid (HEDTA) (pKa values of about 2.6 and 5.4), ethylenediamine-N,N′-disuccinic acid (EDSS) (pKa values of about 2.4), N-(2-hydroxyethyl)iminodiacetic acid (HEIDA) (pKa values of about 2.2), or methylglycine diacetic acid (MGDA) (pKa values of about 1.6, 2.5, and 10.5). A combination of low pKa values and strong conditional formation constant are a desired characteristic because they lead to efficient metal complexation at lower pH than the optimum pH for a particular phosphonoalkyl agent. For instance, the complexing effect is representative of the strongest metal complexation under conditions of complete acid-base dissociation (deprotonation) of the organic agent (ligand), but this is usually attained at very high pH range (pH much greater than 8). The deprotonated organophosphorous compound comprising a phosphonoalkyl moiety can therefore stabilize released metal cations at low pH and even in HCl media, thus extending the acidity range over which the organophosphorous compound comprising a phosphonoalkyl moiety is active. This may be an advantage when compared to traditional chelating agents such as EDTA and N-(hydroxyethyl)-ethylenediaminetriacetic acid (HEDTA), which typically complex better at higher pHs. In addition, the ability to use lower pH values for a treatment fluid in an acidizing operation may enhance the dissolution of the formation matrix, thus increasing the effectiveness of the acidizing treatment.

In some embodiments, the subterranean formation may have a bottom hole static temperature of about 60° F. or above, of about 100° F. or above, or about 150° F. or above, or about 200° F. or above, or about 250° F. or above, about 300° F. or above, about 350° F. or above, or about 400° F. or above. As the temperature of the subterranean formation increases, the reaction rate of the acid with a carbonate mineral in the subterranean formation may also increase, which in turn may affect interaction of the acid and the carbonate mineral formation (e.g., bulk erosion, wormhole formation, or a combination thereof).

Among the many potential advantages to the methods and compositions of the present disclosure, only some of which are alluded to herein, the methods and compositions of the present disclosure may avoid the need to conduct a separate scale inhibitor squeeze treatment after an acidizing treatment. For example, in some embodiments, the acidizing treatment and the scale inhibitor squeeze treatment may be performed in a single stage. In certain embodiments, the treatments fluids of the present disclosure may be mixed prior to introduction into a wellbore penetrating at least a portion of a subterranean formation.

The methods, systems, and compositions may also help protect acid-reactive surfaces, particularly during subterranean treatment operations in which acids are used. Excessive reactivity of some acid-reactive substances, particularly those containing an acid-reactive surface, may preclude contacting the acid-reactive surface with an acid for any significant length of time before the effective acid concentration is rapidly consumed by the mineral surface, thereby limiting the transport of such acid to distally located zones in the reservoir. Such excessive reactivity may be particularly problematic for proper fluid placement in subterranean treatment operations, where there may be issues of wellbore damage, ineffective stimulation, and combinations thereof. In addition, the high reactivity of acids with some acid-reactive surfaces can preclude delivery of the acid to a wellbore location where the acid's presence is more desired. For example, when low permeability formations are encountered and there is an insufficient rate of introduction of the acid into the formation (e.g., via pumping at or close to the optimum injection rate), or when screens or slotted liners are present, it may be difficult to properly place an acid due to its premature reaction with another acid-reactive material. Highly permeable thief zones also may preclude placement of an acid into a desired location within a subterranean formation (e.g., a wellbore penetrating the subterranean formation).

In certain embodiments, the organophosphorous compound comprising a phosphonoalkyl moiety may be an N-(phosphonoalkyl)iminodiacetic acid. In some embodiments, the N-(phosphonoalkyl)iminodiacetic acid may be supplied as a solid compound. The solid form of most N-(phosphonoalkyl)iminodiacetic acids are believed to have limited solubility in water. In particular, it is expected that most of the solid forms of N-(phosphonoalkyl)iminodiacetic acids have a solubility of less than or equal to about 0.5% weight/volume (“w/v”). In certain embodiments, the solubility of the N-(phosphonoalkyl)iminodiacetic acid may be increased. In some embodiments, the methods of the present disclosure may include partially or entirely neutralizing the N-(phosphonoalkyl)iminodiacetic acid using a base. Without intending to be limited to any particular theory or mechanism, it is believed that at least partially neutralizing the N-(phosphonoalkyl)iminodiacetic acid to create an organic salt derivative thereof may increase the solubility of the N-(phosphonoalkyl)iminodiacetic acid in water.

In certain embodiments, the N-(phosphonoalkyl)iminodiacetic acid may have the following structure:

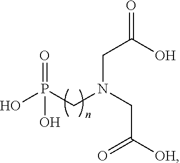

wherein n is an integer ranging between 1 and about 6. In some embodiments, the N-(phosphonoalkyl)iminodiacetic acid may be N-(phosphonomethyl)iminodiacetic acid (“PMIDA”), in which n is 1. In some embodiments, additional functionality also may be introduced to the N-(phosphonoalkyl)iminodiacetic acid to further tailor its solubility, pKa values, and/or biodegradation rate, for example.

In some embodiments, the treatment fluids of the present disclosure may be created by first at least partially neutralizing the organophosphorous compound comprising a phosphonoalkyl moiety (e.g. N-(phosphonoalkyl)iminodiacetic acid) with a base to form an aqueous mixture of an organic salt derivative of the organophosphorous compound comprising a phosphonoalkyl moiety. For example, in embodiments where the organophosphorous compound comprising a phosphonoalkyl moiety is an N-(phosphonoalkyl)iminodiacetic acid, and, more specifically, is PMIDA, the following reaction may occur:

PMIDA(s)+MOH(aq)→PMIDA(ⁿ⁻)M(ⁿ⁺)(aq)+H₂O.

As shown in the reaction above, in certain embodiments, the base may be a Brønsted base. In some embodiments, the base may be an alkali hydroxide, e.g., MOH in the reaction above, wherein M may be selected from the group consisting of lithium, sodium, potassium, rubidium, and cesium. In other embodiments, the base may be ammonium hydroxide. For example, in embodiments where the base is ammonium hydroxide, M is NH₄⁺. In still other embodiments, the base may be a tetraalkyl ammonium hydroxide. For example, in embodiments where the base is tetramethylammonium hydroxide, M is N(CH₃)₄⁺. In certain embodiments, the reaction above may be carried out by adding the organophosphorous compound comprising a phosphonoalkyl moiety to an excess volume or molar excess of the base. It is believed that adding the organophosphorous compound comprising a phosphonoalkyl moiety to the base instead of adding the base to the organophosphorous compound comprising a phosphonoalkyl moiety may result in a greater percent solubility of the organic salt derivative of the organophosphorous compound comprising a phosphonoalkyl moiety in water.

In certain embodiments, the aqueous mixture of an organic salt derivative of the organophosphorous compound comprising a phosphonoalkyl moiety may then be combined with an acid component. In some embodiments, the acid component may be an organic or mineral acid. In other embodiments, the acid component may be an acid-generating compound. In still other embodiments, the acid component may be a mixture of an organic or mineral acid and an acid-generating compound. Examples of acid components that may be used according to certain embodiments of the present disclosure include, for example, hydrochloric acid, hydrobromic acid, formic acid, acetic acid, chloroacetic acid, dichloroacetic acid, trichloroacetic acid, methanesulfonic acid, citric acid, maleic acid, glycolic acid, lactic acid, malic acid, oxalic acid, sulfamic acid, succinic acid, urea-stabilized or allylurea derivatives of the halide acids or of oxyanion acids where the oxyanion comprises a central atom selected from one of C, N, P, S, Se, Si, or similar, and any combination thereof. In some embodiments, the acid component may be generated from an acid-generating compound. Examples of suitable acid-generating compounds may include, but are not limited to, esters, aliphatic polyesters, orthoesters, poly(orthoesters), poly(lactides), poly(glycolides), poly(ε-caprolactones), poly(hydroxybutyrates), poly(anhydrides), phthalates, terephthalates, ethylene glycol monoformate, ethylene glycol diformate, diethylene glycol diformate, glyceryl monoformate, glyceryl diformate, glyceryl triformate, triethylene glycol diformate, formate esters of pentaerythritol, polyurea or urea polymers of HCl complexes, the like, any derivative thereof, and any combination thereof.

In some embodiments, the treatment fluids described herein may be substantially free of hydrofluoric acid or a hydrofluoric acid-generating compound (e.g., when the formation includes siliceous materials). As used herein, a treatment fluid will be considered to be substantially free of hydrofluoric acid or a hydrofluoric acid-generating compound when there is less than about 0.5% w/v hydrofluoric acid (or generatable hydrofluoric acid). In embodiments where there is any hydrofluoric acid (or generatable hydrofluoric acid) present and there is an antimony or bismuth salt, such inclusion of HF acid or generating salt is only intended to be used for the purpose of aiding with corrosion inhibition of metallic components in the course of the treatment operation and not for the purpose of generating and utilizing HF acid in any form. In other embodiments, the treatment fluids may be free of hydrofluoric acid or a hydrofluoric acid-generating compound. Hydrofluoric acid-generating compounds may include substances such as, for example, potassium hydrogen difluoride, sodium hydrogen difluoride, pyridinium fluoride, imidazolium fluoride, ammonium fluoride, or ammonium bifluoride salts. The inclusion or omission of hydrofluoric acid or hydrofluoric acid-generating compounds may be determined based on the composition of the subterranean formation, specifically the presence of siliceous material.

In certain embodiments, the acid components of the present disclosure may be contained within, or mixed with, a carrier fluid. Suitable carrier fluids for use in certain embodiments of the present disclosure may comprise an aqueous fluid or an oleaginous carrier fluid as their continuous phase. Suitable aqueous carrier fluids may include, for example, fresh water, acidified water, salt water, seawater, brackish water, produced water, flowback water, brine (e.g., a saturated salt solution), or an aqueous salt solution (e.g., a non-saturated salt solution). Aqueous carrier fluids may be obtained from any suitable source. In some embodiments, an organic co-solvent may be included with an aqueous carrier fluid. Suitable organic co-solvents may include, but are not limited to, glycols and alcohol solvents, for example. When present, the amount of the organic co-solvent may range between about 1% to about 50% by volume of the treatment fluid. In other various embodiments, the carrier fluid of the treatment fluids may comprise an oleaginous carrier fluid. Suitable oleaginous carrier fluids may include, for example, an organic solvent, a hydrocarbon, oil, a refined component of oil, or any combination thereof.

In some embodiments, the addition of the acid component may cause the organophosphorous compound comprising a phosphonoalkyl moiety (e.g., N-(phosphonoalkyl)iminodiacetic acid) to precipitate out of solution into a solid form. For example, taking the same PMIDA solution described above and adding hydrochloric acid may result in the following reaction:

PMIDA(s)+MOH(aq)→PMIDA(ⁿ⁻)M(ⁿ⁺)(aq)+H₂O; +HCl(aq)→HCl(aq),PMIDA(s)+M⁺Cl⁻(aq)+H₂O.

The above reaction may be an exothermic reaction. The treatment fluids of the present disclosure may be formed by mixing the organophosphorous compound and acid component at a wellbore treatment field location or job site. The organophosphorous compound and acid component may be mixed after the organophosphorous compound comprising a phosphonoalkyl moiety and acid component have been pumped to a pressure sufficient to perform the wellbore treatment operation.

In certain embodiments, the organophosphorous compound comprising a phosphonoalkyl moiety is at least partially solubilized in the acid component. As used herein, the term “at least partially solubilized,” and grammatical variants thereof, with reference to the organophosphorous compound comprising a phosphonoalkyl moiety in the acid component refers to dissolution of at least about 2% weight per volume (w/v) of the organophosphorous compound comprising a phosphonoalkyl moiety in the acid component at room temperature. As used herein, the term “room temperature” refers to about 15° C. to about 25° C. The remaining excess organophosphorous compound comprising a phosphonoalkyl moiety may be suspended in the acid component while it is undergoing dynamic fluid flow at room temperature. As temperatures increase (e.g., as the treatment fluid is introduced into a subterranean formation and encounters downhole temperatures), the solubility of the organophosphorous compound comprising a phosphonoalkyl moiety in the acid component may increase. Indeed, the solubility of the organophosphorous compound comprising a phosphonoalkyl moiety increases as a function of acid concentration, and temperature. Table 1 below shows the saturation concentrations of PMIDA in water and several mixtures of HCl at various temperatures.

TABLE 1
Solubility of PMIDA in HCl
Solubility (w/v %)

| | | | Std. | | Std. | | Std. |
|---|---|---|---|---|---|---|---|
| | | Average | Dev. | Average | Dev. | Average | Dev. |
| Pressure | Solvent | 100° F. | | 150° F. | | 200° F. | |
| 200 psi | H₂O | 1.83 | 0.17 | 2.87 | 0.46 | 5.11 | 0.40 |
| | 15% HCl | 4.11 | 0.60 | 9.57 | 0.63 | 20.34 | 0.48 |
| Atm. | H₂O | 2.26 | 0.56 | 3.19 | 0.52 | 4.79 | 0.36 |
| | 15% HCl | 3.06 | 0.59 | 7.22 | 0.58 | 16.60 | 1.19 |
| | 10% HCl | 2.00 | 0.08 | 4.91 | 0.43 | 10.10 | 0.62 |
| | 7.5% HCl | 1.74 | 0.07 | 3.97 | 0.25 | 10.00 | 0.61 |

In certain embodiments, the organophosphorous compound comprising a phosphonoalkyl moiety or any salt thereof may be deposited as a coating onto the acid-reactive surface while the acid-reactive surface is contacted with the acid component. In some embodiments, the organophosphorous compound comprising a phosphonoalkyl moiety, or any salt thereof, and the acid component may be contacted with the acid-reactive surface concurrently. Concurrent contact may occur from separate streams of the acid component and the organophosphorous compound comprising a phosphonoalkyl moiety, or any salt thereof, or these two components may be together in a combined fluid phase, such as a subterranean treatment fluid. In some embodiments, when contacted concurrently with the acid-reactive surface, the organophosphorous compound comprising a phosphonoalkyl moiety, or any salt thereof, may be in an insoluble form in a fluid from which it is deposited to promote formation of the protective coating. The organophosphorous compound comprising a phosphonoalkyl moiety may be fully protonated when in the insoluble form. Even when deposited concurrently in the presence of an acid component, a protective coating formed from the organophosphorous compound comprising a phosphonoalkyl moiety, or any salt thereof, may still be formed rapidly enough to mitigate erosion of the acid-reactive surface by the acid component.

In certain embodiments, the concentration of the organophosphorous compound comprising a phosphonoalkyl moiety, or any salt thereof, in the treatment fluid may range between about 0.5 wt. % to about 70 wt. %. In other embodiments, the concentration may range between about 1 wt. % and about 25 wt. %. In still other embodiments, the concentration may range between about 1.5 wt. % and about 20 wt. %, or from about 3% to 18%, or from about 5% to 12%, or from about 7% to 10%. Depending on the pH of the treatment fluid and the concentration, the organophosphorous compound comprising a phosphonoalkyl moiety, or any salt thereof, may be substantially soluble in the treatment fluid, or it may be at least partially suspended in the treatment fluid. When suspended, it may be possible to deposit the protective coating as a filter cake on an acid-reactive surface or substance when treating a subterranean formation. Treatment fluids comprising a solubilized organophosphorous compound comprising a phosphonoalkyl moiety, or any salt thereof, may be used to directly form a metal complex upon the acid-reactive surface.

In one or more embodiments, the treatment fluids described herein may further comprise any number of additives that are commonly used in downhole operations including, for example, silica scale control additives, corrosion inhibitors, corrosion inhibitor intensifiers, surfactants, viscoelastic surfactants, surface modification agents and tackifying agents, surface and tensioactive agents, gel stabilizers, anti-oxidants, polymer degradation prevention additives, relative permeability modifiers, scale inhibitors, foaming agents, defoaming agents, antifoaming agents, emulsifying agents, de-emulsifying agents, iron control agents, proppants or other particulates, particulate diverters of inorganic or organic properties of synthetic or industrial production, salts, acids, fluid loss control additives, gas, catalysts, clay control agents, dispersants, flocculants, scavengers (e.g., H₂S scavengers, CO₂ scavengers or O₂ scavengers), gelling agents, lubricants, friction reducers, bridging agents, viscosifiers, weighting agents, solubilizers, pH control agents (e.g., buffers), hydrate inhibitors, consolidating agents, bactericides, biocides, catalysts, clay stabilizers, breakers, delayed release breakers, energizing fluids (e.g., CO₂, N₂, CH₄, C₂H₆, propane, butane, LNG), anti-sludging agents, thinners, solvents and co-solvents, freezing point depressants, microemulsions, diverting agents and particulates including microparticulates, proppant and microproppants including natural sands, polymeric and macromolecular permeability modifiers (relative permeability modifiers), crosslinkers (organic), complexing and chelating agents, and the like. Any combination of these additives may be used as well. Based on the teachings of this disclosure, one of ordinary skill in the art will be able to formulate a treatment fluid having properties suitable for a given application.

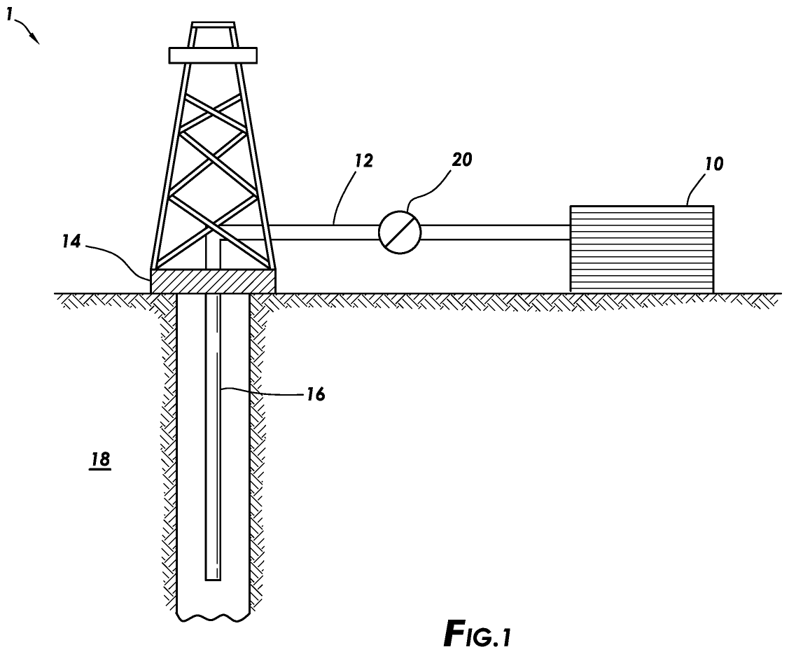

In certain embodiments, systems configured for delivering a treatment fluid of the present disclosure to a downhole location are described herein. FIG. 1 shows an illustrative schematic of a system that can deliver treatment fluids of the present disclosure to a downhole location, according to one or more embodiments. It should be noted that while FIG. 1 generally depicts a land-based system, it is to be recognized that like systems may be operated in subsea locations as well. As depicted in FIG. 1, system 1 may include mixing tank 10, in which a treatment fluid of the present disclosure may be formulated. The treatment fluid may be conveyed via line 12 to wellhead 14, where the treatment fluid enters tubular 16, tubular 16 extending from wellhead 14 into subterranean formation 18. Upon being ejected from tubular 16, the treatment fluid may subsequently penetrate into subterranean formation 18. In some instances, tubular 16 may have a plurality of orifices (not shown) through which the treatment fluid of the present disclosure may enter the wellbore proximal to a portion of the subterranean formation 18 to be treated. In some instances, the wellbore may further comprise equipment or tools (not shown) for zonal isolation of a portion of the subterranean formation 18 to be treated.

Pump 20 may be configured to raise the pressure of the treatment fluid to a desired degree before its introduction into tubular 16. It is to be recognized that system 1 is merely exemplary in nature and various additional components may be present that have not necessarily been depicted in FIG. 1 in the interest of clarity. Non-limiting additional components that may be present include, but are not limited to, supply hoppers, valves, condensers, adapters, joints, gauges, sensors, compressors, pressure controllers, pressure sensors, flow rate controllers, flow rate sensors, temperature sensors, and the like.

Although not depicted in FIG. 1, the treatment fluid may, in some embodiments, flow back to wellhead 14 and exit subterranean formation 18. In some embodiments, the treatment fluid that has flowed back to wellhead 14 may subsequently be recovered and recirculated to subterranean formation 18.

The disclosed treatment fluids also may directly or indirectly affect the various downhole equipment and tools that may come into contact with the treatment fluids during operation. Such equipment and tools may include, but are not limited to, wellbore casing, wellbore liner, completion string, insert strings, drill string, coiled tubing, slickline, wireline, drill pipe, drill collars, mud motors, downhole motors and/or pumps, surface-mounted motors and/or pumps, centralizers, turbolizers, scratchers, floats (e.g., shoes, collars, valves, etc.), logging tools and related telemetry equipment, actuators (e.g., electromechanical devices, hydromechanical devices, etc.), sliding sleeves, production sleeves, plugs, screens, filters, flow control devices (e.g., inflow control devices, autonomous inflow control devices, outflow control devices, etc.), couplings (e.g., electro-hydraulic wet connect, dry connect, inductive coupler, etc.), control lines (e.g., electrical, fiber optic, hydraulic, etc.), surveillance lines, drill bits and reamers, sensors or distributed sensors, downhole heat exchangers, valves and corresponding actuation devices, tool seals, packers, cement plugs, bridge plugs, and other wellbore isolation devices, or components, and the like. Any of these components may be included in the systems generally described above and depicted in FIG. 1.

An embodiment of the present disclosure is a method including providing an organophosphorous compound including a phosphonoalkyl moiety; providing an acid component; mixing at least the organophosphorous compound including a phosphonoalkyl moiety and the acid component to form a treatment fluid; introducing the treatment fluid into at least a portion of a subterranean formation; contacting at least a portion of an acid-reactive substance disposed within the subterranean formation with the treatment fluid; forming a spent treatment fluid by allowing the acid component to at least partially spend against the portion of the acid-reactive surface; and allowing the spent treatment fluid to inhibit the formation of at least an amount of scale.

In one or more embodiments described in the preceding paragraph, the step of forming the spent treatment fluid by allowing the acid component to at least partially spend against the portion of the acid-reactive surface further includes raising a pH of the treatment fluid. In one or more embodiments described above, the step of allowing the spent treatment fluid to inhibit the formation of at least an amount of scale within the subterranean formation further includes adsorbing a portion of the organophosphorous compound including a phosphonoalkyl moiety onto the portion of the acid-reactive substance. In one or more embodiments described above, the acid component is selected from the group consisting of hydrochloric acid, methanesulfonic acid, acetic acid, formic acid and any combination thereof. In one or more embodiments described above, the portion of a surface in the wellbore is selected from the group consisting of: a surface of the subterranean formation, a surface of a piece of down-hole equipment, a surface of a pipe, or any combination thereof. In one or more embodiments described above, the acid-reactive substance is carbonate. In one or more embodiments described above, the organophosphorous compound including a phosphonoalkyl moiety is selected from the group consisting of: an N-(phosphonoalkyl)iminodiacetic acids; N-(carboxymethyl)-N-(phosphonomethyl)¬glycine; glycine, N,N′-1,2-ethanediylbis(N-(phosphonomethyl); glyphosine; aminotrimethylene phosphonic acid; sodium aminotris(methylenephosphonate); N-(2-hydroxyethyl)imino-bis(methylphosphonic acid); phosphonic acid, P,P′-((2-propen-1-ylimino)bis(methylene))bis-; phosphonic acid, P,P′,P″-(nitrilotris(methylene))tris-; (nitrilotris(methylene))trisphosphonic acid; ((methylimino)dimethylene)bisphosphonic acid; phosphonic acid, P,P′,P″,P″′-(oxybis(2,1-ethane-diylnitrilobis(methylene))tetrakis-; ((propylimino)bis(methylene))diphosphonic acid; phosphonic acid; P,P′,P″-(nitrilotris(methylene))tris-; (ethylenedinitrilo)-tetramethylenephosphonic acid; ethylenebis(nitrilodimethylene)tetraphosphonic acid; (ethylenebis(nitrilobis¬(methylene)))-tetrakisphosphonic acid; tetrasodium tetrahydrogen (ethane-1,2-diylbis(nitrilobis¬(methylene)))-tetrakisphosphonate; 6-(bis(phosphonomethyl)amino)hexanoic acid; (phenyl¬methyl)imino)-bis(methylene)bisphosphonic acid; a sodium, potassium, ammonium, or tetraalkylammonium salt of any group member herein; and any combination thereof. In one or more embodiments described above, the organophosphorous compound including a phosphonoalkyl moiety is an N-(phosphonoalkyl)iminodiacetic acid. In one or more embodiments described above, the N-(phosphonoalkyl)iminodiacetic acid is PMIDA. In one or more embodiments described above, the step of introducing the treatment fluid into at least a portion of a subterranean formation further includes using one or more pumps to pump the treatment fluid into the portion of the subterranean formation.

Another embodiment of the present disclosure is a method including introducing a treatment fluid including an organophosphorous compound and an acid component into at least a portion of a subterranean formation, wherein the organophosphorous compound further includes a phosphonoalkyl moiety; contacting at least a portion of an acid-reactive substance disposed within the subterranean formation with the treatment fluid; forming a spent treatment fluid by allowing the acid component to at least partially spend against the portion of the acid-reactive surface; and allowing the spent treatment fluid to inhibit the formation of at least an amount of scale within the subterranean formation.

In one or more embodiments described in the preceding paragraph, the step of forming the spent treatment fluid by allowing the acid component to at least partially spend against the portion of the acid-reactive surface further includes raising a pH of the treatment fluid. In one or more embodiments described above, the organophosphorous compound including a phosphonoalkyl moiety is an N-(phosphonoalkyl)iminodiacetic acid. In one or more embodiments described above, the N-(phosphonoalkyl)iminodiacetic acid is PMIDA. In one or more embodiments described above, the acid component includes hydrochloric acid.

Another embodiment of the present disclosure is a method including providing an organophosphorous compound including PMIDA; providing an acid component including hydrochloric acid; mixing at least the PMIDA and the hydrochloric acid to form a treatment fluid; introducing the treatment fluid into at least a portion of a subterranean formation; contacting at least a portion of an acid-reactive substance disposed within the subterranean formation with the treatment fluid; forming a spent treatment fluid by allowing the acid component to at least partially spend against the portion of the acid-reactive surface; and allowing the spent treatment fluid to inhibit the formation of at least an amount of scale in at least a portion of the subterranean formation.

In one or more embodiments described in the preceding paragraph, the step of forming the spent treatment fluid by allowing the acid component to at least partially spend against the portion of the acid-reactive surface further includes raising a pH of the treatment fluid. In one or more embodiments described above, the acid-reactive substance is carbonate. In one or more embodiments described above, the step of allowing the spent treatment fluid to inhibit the formation of at least an amount of scale within the subterranean formation further includes adsorbing a portion of the PMIDA onto the portion of the acid-reactive substance. In one or more embodiments described above, the step of allowing the spent treatment fluid to inhibit the formation of at least an amount of scale within the subterranean formation further includes allowing the PMIDA to complex one or more metal ions in the subterranean formation.

To facilitate a better understanding of the embodiments of the present disclosure, the following examples of preferred or representative embodiments are given. In no way should the following examples be read to limit, or to define, the scope of the disclosure.

### Examples

A core flow test was performed to demonstrate the scale inhibition properties of the organophosphorous compound comprising a phosphonoalkyl moiety in a spent treatment fluid of the present disclosure. A treatment fluid comprising 15% w/v HCl and 7% w/v PMIDA was pumped through a 1.5 inch by 6 inch Indiana Limestone (ILS) calcium carbonate core at a rate of 0.5 mL/min and a temperature of 200° F. An aliquot of the effluent comprising the spent HCl and PMIDA was taken during this stage for use in subsequent scale inhibition testing. The volume of the aliquot was 1620 mL and the phosphorous concentration was 26 ppm (correlating to 190.5 ppm of PMIDA). The pH of the aliquot of the effluent was greater than 3.5, thereby showing that the treatment fluid was at least partially spent.

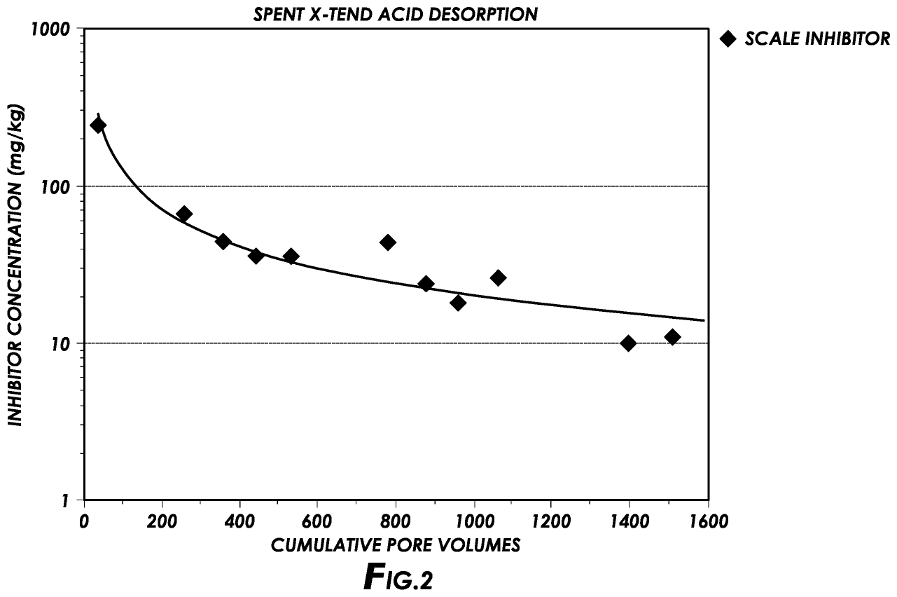

The desorption characteristics of the spent treatment fluid were measured by subsequently flowing 2% w/v KCl brine through the same carbonate core. The 2% w/v KCl brine was flowed through the core for >1,500 PV at a temperature of 200° F. The effluent was collected and the PMIDA concentration (as a function of phosphorous concentration in mg/kg) was plotted versus the volume (expressed as cumulative pore volumes) in FIG. 2.

A dynamic scale test was then performed to show the scale inhibition properties of PMIDA in the spent treatment fluid. A dynamic loop system was used to test the fluids shown in Table 2 below.

TABLE 2
Scale Test Fluid Concentration

| | | 0.25× Spent | 0.5× Spent | Spent |
|---|---|---|---|---|
| Component | Control | Fluid | Fluid | Fluid |
| PMIDA | 0 ppm | 6.5 ppm | 13 ppm | 26 ppm |
| Ca²⁺ | 3,312 ppm | Not | Not | Not |
| | | measured | measured | measured |
| Mg²⁺ | 440 ppm | Not | Not | Not |
| | | measured | measured | measured |
| Na⁺ | 25,963 ppm | Not | Not | Not |
| | | measured | measured | measured |
| HCO₃⁻ | 5,346 ppm | Not | Not | Not |
| | | measured | measured | measured |
| TDS | 82,241 ppm | Not | Not | Not |
| | | measured | measured | measured |

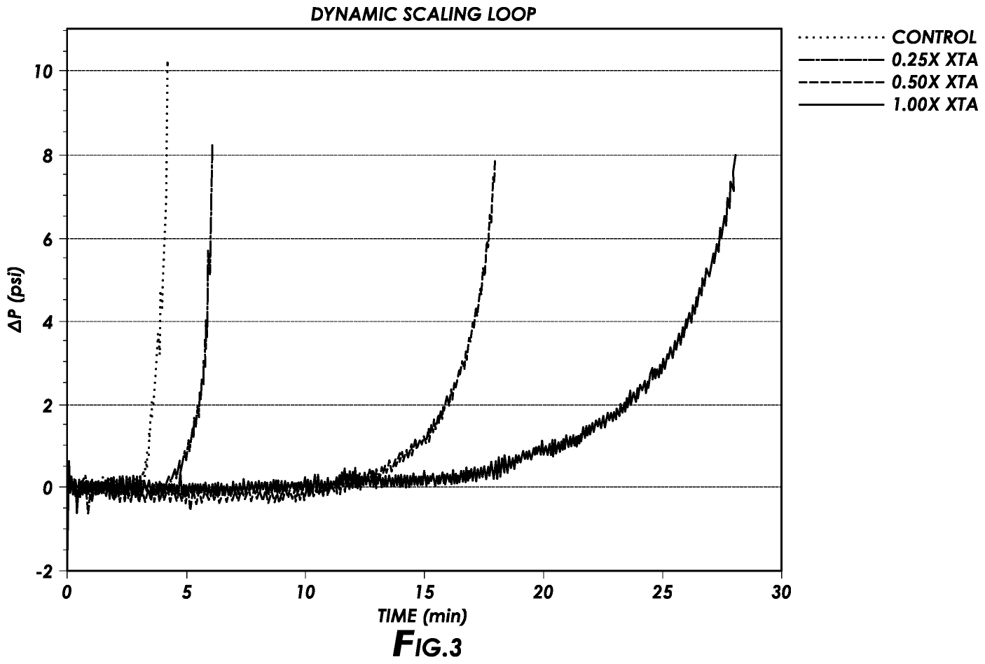

For the control fluid, a brine based on the compositions shown in Table 2 was prepared. For the spent fluids, the previously collected aliquot of the effluent comprising the spent HCl and PMIDA was combined with the anionic components shown in Table 2. This anionic brine was combined with a cationic brine in the dynamic loop system to represent a scaling or inhibited brine. Each fluid was then pumped at 4 mL/min through the dynamic loop system at 4000 psi and 200° F. and the differential pressure in the system was plotted as function of time. The results of this test are shown in FIG. 3.

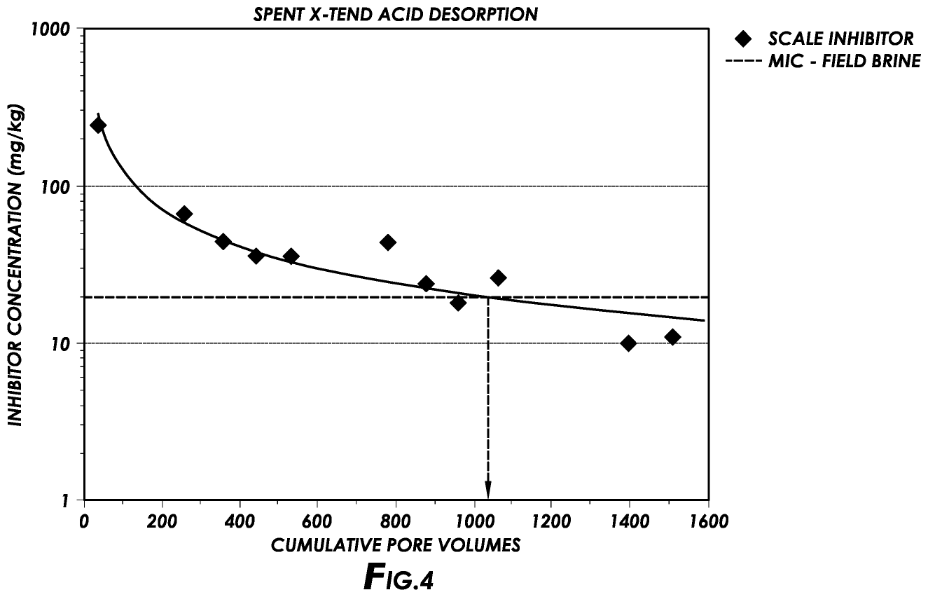

As shown in FIG. 3, the control fluid generated scale sufficient to raise the differential pressure within the dynamic loop system in less than 5 minutes. In some embodiments, extending the time to generate scale by a factor of three may generally be sufficient for certain applications described herein. Thus, the 0.5× Spent Fluid may provide sufficient scale inhibition as the test results showed a delayed pressure rise of approximately 15 minutes. FIG. 4 shows that the concentration of PMIDA in the spent treatment fluid is at or above the concentration of PMIDA found in the 0.5× Spent Fluid (i.e., a phosphorous concentration of 13 ppm (correlating to 95.2 ppm of PMIDA) until approximately 1000 cumulative pore volumes of bring have been pumped through the core sample.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the specification and attached claims are approximations that may vary depending upon the desired properties sought to be obtained by the embodiments of the present disclosure. At the very least, and not as an attempt to limit the application of the doctrine of equivalents to the scope of the claim, each numerical parameter should at least be construed in light of the number of reported significant digits and by applying ordinary rounding techniques.

Therefore, the present disclosure is well adapted to attain the ends and advantages mentioned as well as those that are inherent therein. The particular embodiments disclosed above are illustrative only, as the present disclosure may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present disclosure. The disclosure illustratively disclosed herein suitably may be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range are specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces.

What is claimed is:

1. A method comprising:
providing an organophosphorous compound comprising a phosphonoalkyl moiety, wherein the phosphonoalkyl moiety is in an insoluble form;
providing an acid component;
mixing at least the organophosphorous compound comprising a phosphonoalkyl moiety and the acid component to form a treatment fluid;
introducing the treatment fluid into at least a portion of a subterranean formation;
contacting at least a portion of an acid-reactive substance disposed within the subterranean formation with the treatment fluid;
forming a spent treatment fluid by allowing the acid component to at least partially spend against the portion of the acid-reactive surface; and
allowing the organophosphorous compound comprising a phosphonoalkyl moiety of the spent treatment fluid to inhibit the formation of at least an amount of scale on at least a portion of a surface in the subterranean formation, wherein a step of allowing the spent treatment fluid to inhibit the formation of at least an amount of scale within the subterranean formation further comprises adsorbing a portion of the organophosphorous compound comprising a phosphonoalkyl moiety onto the portion of the acid-reactive substance.

2. The method of claim 1, wherein the step of forming the spent treatment fluid by allowing the acid component to at least partially spend against the portion of the acid-reactive surface further comprises raising a pH of the treatment fluid.

3. (canceled)

4. The method of claim 1, wherein the acid component is selected from the group consisting of hydrochloric acid, methanesulfonic acid, acetic acid, formic acid and any combination thereof.

5. The method of claim 1, wherein the portion of a surface in the wellbore is selected from the group consisting of: a surface of the subterranean formation, a surface of a piece of down-hole equipment, a surface of a pipe, or any combination thereof.

6. The method of claim 1, wherein the acid-reactive substance is carbonate.

7. The method of claim 1, wherein the organophosphorous compound comprising a phosphonoalkyl moiety is selected from the group consisting of: an N-(phosphonoalkyl)iminodiacetic acids; N-(carboxymethyl)-N-(phosphonomethyl)¬glycine; glycine, N,N′-1,2-ethanediylbis(N-(phosphonomethyl); glyphosine; aminotrimethylene phosphonic acid; sodium aminotris(methylenephosphonate); N-(2-hydroxyethyl)imino-bis(methylphosphonic acid); phosphonic acid, P,P′-((2-propen-1-ylimino)bis(methylene))bis-; phosphonic acid, P,P′,P″-(nitrilotris(methylene))tris-; (nitrilotris(methylene))trisphosphonic acid; ((methylimino)dimethylene)bisphosphonic acid; phosphonic acid, P,P′,P″,P′″-(oxybis(2,1-ethane-diylnitrilobis(methylene))tetrakis-; ((propylimino)bis(methylene))diphosphonic acid; phosphonic acid; P,P′,P″-(nitrilotris(methylene))tris-; (ethylenedinitrilo)-tetramethylenephosphonic acid; ethylenebis(nitrilodimethylene)tetraphosphonic acid; (ethylenebis(nitrilobis¬(methylene)))-tetrakisphosphonic acid; tetrasodium tetrahydrogen (ethane-1,2-diylbis(nitrilobis¬(methylene)))-tetrakisphosphonate; 6-(bis(phosphonomethyl)amino)hexanoic acid; (phenyl¬methyl)imino)-bis(methylene)bisphosphonic acid; a sodium, potassium, ammonium, or tetraalkylammonium salt of any group member herein; and any combination thereof.

8. The method of claim 7, wherein the organophosphorous compound comprising a phosphonoalkyl moiety is an N-(phosphonoalkyl)iminodiacetic acid.

9. The method of claim 8, wherein the N-(phosphonoalkyl)iminodiacetic acid is N-phosphonomethyl iminodiacetic acid (PMIDA).

10. The method of claim 1, wherein the step of introducing the treatment fluid into at least a portion of a subterranean formation further comprises using one or more pumps to pump the treatment fluid into the portion of the subterranean formation.

11. A method comprising:
introducing a treatment fluid comprising an organophosphorous compound and an acid component into at least a portion of a subterranean formation, wherein the organophosphorous compound further comprises a phosphonoalkyl moiety, wherein the phosphonoalkyl moiety is in an insoluble form;
contacting at least a portion of an acid-reactive substance disposed within the subterranean formation with the treatment fluid;
forming a spent treatment fluid by allowing the acid component to at least partially spend against the portion of the acid-reactive surface, wherein the spent treatment fluid comprises a pH greater than 2; and
allowing the spent treatment fluid to inhibit the formation of at least an amount of scale within the subterranean formation, wherein a step of allowing the spent treatment fluid to inhibit the formation of at least an amount of scale within the subterranean formation further comprises adsorbing a portion of the organophosphorous compound comprising a phosphonoalkyl moiety onto the portion of the acid-reactive substance.

12. The method of claim 11, wherein the step of forming the spent treatment fluid by allowing the acid component to at least partially spend against the portion of the acid-reactive surface further comprises raising a pH of the treatment fluid.

13. The method of claim 11, wherein the organophosphorous compound comprising a phosphonoalkyl moiety is an N-(phosphonoalkyl)iminodiacetic acid.

14. The method of claim 13, wherein the N-(phosphonoalkyl)iminodiacetic acid is N-phosphonomethyl iminodiacetic acid (PMIDA).

15. The method of claim 11, wherein the acid component comprises hydrochloric acid.

16. A method comprising:
providing an organophosphorous compound comprising N-phosphonomethyl iminodiacetic acid (PMIDA), wherein the PMIDA is in an insoluble form;
providing an acid component comprising hydrochloric acid;
mixing at least the N-phosphonomethyl iminodiacetic acid (PMIDA) and the hydrochloric acid to form a treatment fluid;
introducing the treatment fluid into at least a portion of a subterranean formation;
contacting at least a portion of an acid-reactive substance disposed within the subterranean formation with the treatment fluid;
forming a spent treatment fluid by allowing the acid component to at least partially spend against the portion of the acid-reactive surface, wherein the N-phosphonomethyl iminodiacetic acid (PMIDA) is present in the spent treatment fluid in a concentration of from about 95.2 ppm to about 190.5 ppm; and
allowing the spent treatment fluid to inhibit the formation of at least an amount of scale in at least a portion of the subterranean formation, wherein a step of allowing the spent treatment fluid to inhibit the formation of at least an amount of scale within the subterranean formation further comprises adsorbing a portion of the organophosphorous compound comprising a phosphonoalkyl moiety onto the portion of the acid-reactive substance.

17. The method of claim 16, wherein the step of forming the spent treatment fluid by allowing the acid component to at least partially spend against the portion of the acid-reactive surface further comprises raising a pH of the treatment fluid.

18. The method of claim 16, wherein the acid-reactive substance is carbonate.

19. The method of claim 16, wherein the step of allowing the spent treatment fluid to inhibit the formation of at least an amount of scale within the subterranean formation further comprises adsorbing a portion of the N-phosphonomethyl iminodiacetic acid (PMIDA) onto the portion of the acid-reactive substance.

20. The method of claim 16, wherein the step of allowing the spent treatment fluid to inhibit the formation of at least an amount of scale within the subterranean formation further comprises allowing the N-phosphonomethyl iminodiacetic acid (PMIDA) to complex one or more metal ions in the subterranean formation.

21. The method of claim 1, wherein the organophosphorous compound and the acid component are transported downhole concurrently in separate streams and allowed to mix downhole.
